(19) United States
(12) Patent Application Publication
(10) Pub. No.: US 2003/0220932 A1
(43) Pub. Date: Nov. 27, 2003

(54) Construction of a system of categories for lists

(76) Inventor: Petr Hejl, White Rock (CA)

Correspondence Address: Clifford W. Vermette, Vermette & Co., Box 40, Granville Square, 200 Granville Street, Suite 230, Vancouver, BC, V6C 1S4, CA

(21) Appl. No.: 10/444,994

(22) Filed: May 27, 2003

(30) Foreign Application Priority Data
May 24, 2002 (CA) 2,387,297

(51) Int. Cl. G06F 7/00

(52) U.S. Cl. 707/100

(57) ABSTRACT

The invention is concerned with lists (directories, yellow pages and the like). At present, identical or closely related real categories are often named in the lists using single and mutually different names. The categories are created mostly by random, without using some formal system. That is why large number of categories is created and the categories overlap.

Moreover the relations between categories are chosen more or less by random, while nearly any two categories can have relation to each other in principle. Following this, enormous number of categories relations are created. And because of large number of categories and categories relations it is difficult to insert the records into the lists and to search the desired records in the lists. From this reason the search engines become more popular than the lists.

The new solution, suggested in the invention, creates the categories based on these requirements:

one to one function between real categories and word categories

categories are as broad as possible

categories do not overlap

The method to construct the categories comprises:

constructing of word categories as sets of related words (e.g. the ,,Apparatus and Appliances and Devices” category)

defining fixed categories as general categories applicable to most other categories (e.g. the ,,Production and Manufacture and Making and Fabrication” category)

constructing free categories by selecting all categories which are not fixed (e.g. the ,,Automotive and Vehicles” category)

placing said fixed categories in all of said free categories

constructing relations between said free categories

Using the suggested method, the categories do not much overlap, the number of categories and categories relations decreases, the insertion and searching of the records in the lists is simple.

### FIELD

The present invention relates to a new method of constructing systems of categories for lists (directories, yellow pages and the like). Such lists may be stored on different media paper, computers, internet etc.

### BACKGROUND

In existing lists, identical or closely related objects or activities etc. are often named differently and, therefore, are placed in different categories. This creates too many categories and/or overlapping categories on a large scale. It is often a problem for the users of these lists to place records into the right categories or to find the categories where the records they are searching are placed.

In lists, there is a great deal of interplay between superior and subordinate categories. It is very difficult, if not impossible, to check for every category, and to determine which categories are in sub-categories and which are not.

In existing lists, the subcategories of any given category are chosen more or less randomly (though based on the knowledge or experience of the list authors). This causes a nonsystematic category structure and presents difficulties when inserting and searching records in such lists. Some examples of closely related categories on the same level with different names are the following:

Apparatus, Appliances, Devices

Drafting, Projecting, Constructing

Production, Manufacture, Making, Fabrication

Sale, Buy, Shops, Stores, Shopping, Retail

Sea, Ocean, Marine, Maritime, Naval, Nautical

Shopping Centers, Supermarkets, Hypermarkets, Megamarkets, Marts

Software, Programs

Examples of related categories having a superior-subordinate relation are the following:

Art—Film—Actors

Computers—Software—Databases—Programming Languages

Internet—WWW—Hosting—Companies

Vehicles—Cars—Sale

On the one hand, there exist real categories in the surrounding world. These are sets of subjects, objects, activities, organizations, people, animals, things, etc. Examples of categories from these sets are women, cars, production, reading, hospitals, doctors, dogs, and keys.

On other hand, there are word categories, i.e. words which name, define, or describe these real categories. The existing method of categorization creates categories with single words. This is an imprecise method since there are often more words which are required to properly identify and define a category. For example, the real category, which is composed of producing activities, is projected into the word categories “Production”, “Manufacture”, “Making”, “Fabrication”.

There is no exact method of constructing the superior-subordinate categories.

Accordingly, an object of the present invention is to construct systems of categories for lists, in which it is very simple to place records into the right categories and to find the right categories, where the searched items are placed.

### SUMMARY OF THE INVENTION

The systems of categories should comply with the following requirements to the extent possible:

1. One-to-one function between real categories and word categories (i.e. word categories will cover all real categories); see FIG. 1 for good one-to-one function and FIG. 2 for bad one-to-one function

2. Categories are as broad as possible (i.e. number of categories is small)

3. Categories do not overlap (i.e., with respect to requirement 1, the number of categories is large)

Since we are primarily concerned with real categories, these requirements may not always be fulfilled. We have finite number of word categories available to work with in what could be an infinite number of categories. And the requirements 2. and 3. are contradictory.

### BRIEF DESCRIPTION OF THE DRAWINGS

FIG. 1 is a schematic representation of the correspondence between real categories and sets of words for a correct representation; and

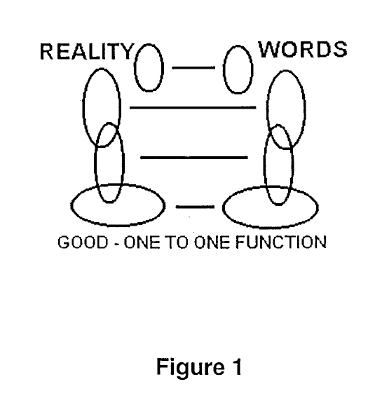

FIG. 2 is a schematic representation of the correspondence between real categories and sets of words for an incorrect representation.

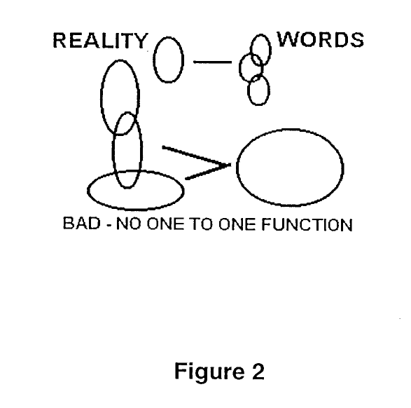

FIG. 3 is a schematic representation of the correspondence between real categories and word categories used in old methods; the word categories are named by single words.

FIG. 4 is a schematic representation of the correspondence betweenreal categories and word categories in suggested new method; the word categories are named by sets of words.

### DETAILED DESCRIPTION WITH REFERENCE TO THE DRAWINGS

1. Word Categories Sets Method

Disclaimer (Definition):

Word categories are not single words. Word categories are sets of words.

In the Word Categories Sets Method the word categories are not words and the projection is not from real categories into single words.

Instead:

We define word categories to be sets of words. These sets contain words with identical or similar content. The real categories are projected into these sets of words.

As names of these word categories (sets) we use:

the most significant word of the category

selected words from the category

all words from the category.

### Examples

The real category, which consists of various functional instruments such as mobile phones, calculators, tape measure, etc is projected into the word category which is the set {Apparatus, Appliances, Devices}.

The real category, which consists of activities, which produce something is projected into the word category: {Production, Manufacturing, Making, Fabrication}.

The real category, which concerns seas and oceans is projected into the word category: {Sea, Ocean, Marine, Maritime, Naval, Nautical}.

When we choose the most significant word to name the category, the word categories in the examples above will be named:

Apparatus

Production

Sea

When we choose some words from the word category to name this category, the word categories in the examples above will be named e.g.:

Apparatus and Devices

Production and Manufacturing

Sea and Ocean.

When we choose all the words from the word category to name this category, the word categories in examples above will be named:

Apparatus and Appliances and Devices

Production and Manufacturing and Making and Fabrication

Sea and Ocean and Marine and Maritime and Naval and Nautical.

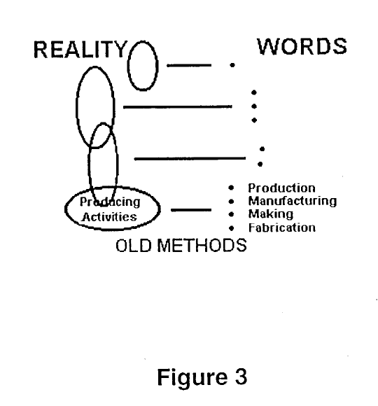

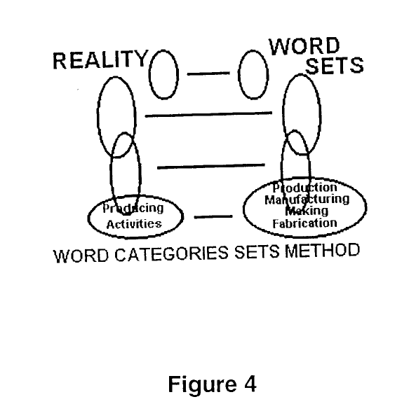

Projection of real categories into word categories is illustrated in FIGS. 3 and 4. FIG. 3 illustrates the old methods, FIG. 4 illustrates the new Word Categories Sets Method.

Fulfillment of Requirements

The Word Categories Sets Method helps to fulfill the three requirements stated above for the construction of categories for lists. Using the Word Categories Sets Method it is possible to choose the categories in a better way. The projection from real categories into the word categories is nearly a one-to-one function. The categories are broad and there is very little overlap.

### EXAMPLE

The old method uses separate categories for Production, Manufacturing. Production may be a subcategory of the category Film or Pharmacy. Manufacturing may be a subcategory of the category Cars, Motors, Toys.

The Word Categories Sets Method uses the category Production and Manufacturing as a sub-category of the category Films, as a sub-category of the category Cars and as a subcategory of any other superior categories, where is something produced.

More Examples of Word Categories, as Used in a List, Constructed by the Word Categories Sets Method

Design and Drafting and Projecting and Constructing

Distribution and Wholesale and Manufacturing Representation

Education and Study and Training

Manipulation and Handling and Loading

Natural and Organic and Sustainable and Ecofriendly

Registration and Licencing and Accreditation

Security and Safety and Safe

Trade and Merchandise

Types and Kinds and Species and Genres and Platforms

2. Fixed and Free Categories Method

Disclamer (Definition):

When constructing a relation between superior and subordinate categories, we do not need to consider all category—category pairs. Instead we consider primarily Free Category—Fixed Category pairs, where Fixed Categories is a defined (and limited in number) subset of categories.

The Word Categories Sets Method helps to fulfill the three requirements above. However, it works only for the categories themselves, without considering the relationship between superior and subordinate categories. Once we have constructed categories using the Word Categories Sets Method, we are faced with the problem of how to define the structure of the list, i.e. to construct the tree of categories. In principle, nearly any two categories can be in a superior-subordinate relationship.

Examples

The category Keys is a subordinate category of the categories Hardware, Software.

The category Sheets is a subordinate category of the categories Trees, Books.

The category Wheels is a subordinate category of the categories Cars, Watches, Trains.

Procedure

The number of categories constructed using the Word Categories Sets Method is about 5000. It is possible that be each Category relates to every other Category. This creates large number of relationships, app. 5000×5000=25 000 000. We must consider these relationships. This can be mastered neither by persons nor by computers (computers are quick but semantics is not a well established property of them).

That is why I have found the Fixed and Free Categories Method to reduce the number of mutual categories relations to be considered.

The categories are divided into two types:

Fixed Categories (typically activities)

Free Categories (typically subjects and objects)

Fixed Categories are common categories, which may occur as subordinate in many (nearly all) other categories. These are usually activities which are performed within the given superior categories.

Free Categories are the rest of categories, which are usually subordinated only to some small number of categories.

Simply said when the category is not Fix Category then it is Free Category.

The Principle of the Fixed and Free Categories Method is:

To find all subcategories of a category, we must first examine the Fixed Categories. It is only then that we consider (from our experience) the Free Categories to construct own Subcategories and Related Categories to the given category.

A reasonable category system should have approximately 25 Fixed Categories and 5000 Free Categories. The number of relationships which must be considered is therefore 25×5000=125000.

This a substantially lower number when compared with the 25000000 associations which must be considered in the old method. The 125000 number of possible realationships is acceptable and workable, although still time consuming.

Each Fixed Category can figure practically in all Free Categories contra all Free Categories being created partly from those universal Fixed Categories, and partly from their own Subcategories and Related Categories.

Each Fixed Category contains one universal subcategory, the name of which is ,,This Category in-for all Categories”. This universal subcategory contains all categories, where the Fixed Category occurs (where the Activity is performed or accepted).

Each Free Category contains one universal subcategory, the name of which is ,,Activities and Pasivities in-for this Category”. This universal subcategory contains all Activities and Pasivities, which are performed or accepted in the Free Category.

### Examples

Fixed Category names

Books

Consulting and Couseling

Design and Drafting and Projecting and Constructing

Distribution and Wholesale and Manufacturingrs Representation

Journals and Magazines

Publishing

Production and Manufacturing and Making and Fabrication

Sale and Shops and Stores and Shopping and Retail and Dealing

Software and Programming

Storages and Storing

Free Categories names

Agriculture and Agricultural

Automotive and Vehicles

Aviation and Aerial

Bicycles

Construction and Building

Fashion

Food and Drink

Jewellery

Glass and Glassware

Porcelain and Pottery and China

Trains and Railroads

Welding

Fixed Category Definition

Superior Category:

Commerce and Business and Economy

Fixed Category Defined:

Design and Drafting and Projecting and Constructing

Subcategories of the Category Defined:

Aeroplanes

Apparel and Clothing

Automotive and Vehicles

Boats

Cars

Computers

Construction and Building

Exteriors and Exterior

Fashion

Furniture

Glass and Glassware

Home and Apartment and House

Industry and Industrial

Interiors and Interior

Machines and Machinery

Motorcycles

Paper and Paperware

Porcelain and China

Sailboats

Ships

Tools and Implements

Trains and Railroads

Windows and Shutters

WWW

Yachts

Thinks

Toys

Free Category Definition

This example describes how a Free Category is completed from Fixed Categories and Free Categories, that are both Sub-Categories of the Free Category.

Without sign ,,/”=>>Free SubCategory

With one sign ,,/”=>>Fixed SubCategory

With two signs ,,//”=>>Related Category

Remark:

Related category are word categories, the content of which is semantically near to the concerned category. E.g. the category Tractors is related to the category Automotive.

Superior Category:

Commerce and Business and Economy

Free Category Defined:

Automotive

Subcategories of the Category:

/Advertisement

Aagriculture and Agricultural/Automotive and Vehicles

Airports/Automotive and Vehicles

Airstream/Automotive and Vehicles

/Alternative Fuel/Automotive and Vehicles

Ambulance/Automotive and Vehicles

Amphibian/Automotive and Vehicles

Animals and Zoology/Automotive and Vehicles

/Apparatus and Appliances and Devices

/Armored/Automotive and Vehicles

ATV (All Terrain Vehicles)

/Automation

/Books

/Booksellers

Buses

Cars

/Consulting and Couseling

/Classics and Clasical/Cars

/Design and Projecting and Constructing

/Distribution and Wholesale and Manufacturingrs Representation

Driving Permits

/Education and Study and Training

/Equipment and Supply

Fires and Firemen/Automotive and Vehicles

Funerals/Automotive and Vehicles

/Governing

/Heavy/Automotive and Vehicles

Hovercrafts

/Images and Pictures

/Journals and Magazines

Limousines and Shuttles

Lorries

//Mopeds and Motor Bikes

Motorcycles

/Motors and Engines/Automotive and Vehicles

Parking

/Parts anc Components and Accessories

Passenger Cars

/Police/Automotive and Vehicles

/Production and Manufacturing and Making and Fabrication

/Propulsion

/Production and Manufacturing and Making and Fabrication

/Publishing

/Radio

/Research and Exploration and Surveying and Experiments and Development

RV (Recreational Vehicles)

/Sale and Shops and Stores and Shopping and Retail and Dealing

//Scooters

Snowmobils

/Software and Programming

/Special and Specialty

/Storages and Storing

Street Sweepers

/Television

Tires

/Tools and Implements

/Toys

Towing/Automotive and Vehicles

Trailers

//Tractors

//Trains

//Trikes

Trucks

Utility Cars

/Veteran/Automotive and Vehicles

I claim:

1. A method for constructing systems of categories, comprising:
(a) constructing word categories as sets of related words;
(b) defining fixed categories as general categories applicable to most other categories;
(c) constructing free categories by selecting all categories which are not fixed;
(d) placing said fixed categories in all of said free categories; and
(e) constructing relations between said free categories.
